(19) United States
(12) Patent Application Publication
(10) Pub. No.: US 2025/0250176 A1
(43) Pub. Date: Aug. 7, 2025

(54) NEGATIVE ACTIVE MATERIAL, METHOD OF PREPARING, AND RECHARGEABLE LITHIUM BATTERY INCLUDING SAME

(71) Applicant: SAMSUNG SDI CO., LTD., Yongin-si (KR)

(72) Inventor: Chul YOUM, Yongin-si (KR)

(21) Appl. No.: 19/046,405

(22) Filed: Feb. 5, 2025

(30) Foreign Application Priority Data
Feb. 6, 2024 (KR) 10-2024-0018236

(51) Int. Cl. C01B 33/18; H01M 10/0525

(52) U.S. Cl. CPC C01B 33/182; H01M 10/0525; C01P 2002/02; C01P 2002/54; C01P 2006/16; C01P 2006/40

(57) ABSTRACT

A negative active material and a rechargeable lithium battery including the same are provided. The negative active material includes a porous amorphous carbon matrix; and a silicon oxide doped with the metal capable of (e.g., for) undergoing (e.g., to undergo) reduction, wherein a porosity of the porous amorphous carbon matrix is about 5% to about 25%.

### CROSS-REFERENCE TO RELATED APPLICATION

The present application claims priority to and the benefit of Korean Patent Application No. 10-2024-0018236, filed on Feb. 6, 2024, in the Korean Intellectual Property Office, the entire content of which is incorporated herein by reference.

### BACKGROUND

### 1. Field

Embodiments of the present disclosure relate to a negative active material, a method of preparing the same, and a rechargeable lithium battery including the same.

### 2. Description of the Related Art

Recently, with the rapid spread of electronic devices that use batteries, such as mobile phones, laptop computers, and/or electric vehicles, a demand and/or desire for relatively high-energy density and high-capacity rechargeable lithium batteries is rapidly increasing. Research for improving performances of rechargeable lithium are actively being studied and/or pursued.

Rechargeable lithium batteries may include: a positive electrode and a negative electrode, the positive and negative electrodes (each) including an active material capable of intercalating and deintercalating lithium ions; and an electrolyte solution, and electrical energy is produced by oxidation and reduction reactions when lithium ions are intercalated/deintercalated at (to/from) the positive and negative electrodes.

### SUMMARY

Aspects of one or more embodiments of the present disclosure are directed toward a negative active material exhibiting excellent or suitable charge and discharge efficiency and suppressed or reduced volume expansion.

Aspects of one or more embodiments of the present disclosure are directed toward a method of preparing the negative active material.

Aspects of one or more embodiments of the present disclosure are directed toward a rechargeable lithium battery including the negative active material.

Additional aspects will be set forth in part in the description which follows and, in part, will be apparent from the description, or may be learned by practice of the presented embodiments of the disclosure.

One or more embodiments of the present disclosure provides a negative active material including a porous amorphous carbon matrix; and a silicon oxide doped with a metal capable of undergoing reduction, wherein a porosity of the porous amorphous carbon matrix is about 5% to about 25%.

One or more embodiments of the present disclosure provide a method of preparing a negative active material, including adding a porous amorphous carbon matrix and a metal compound capable of undergoing reduction to a liquid silane compound to prepare a mixture; defoaming the mixture to prepare a defoamed product; condensing the defoamed product to prepare a condensed product; and reducing (e.g., reduction reacting) the condensed product i) to prepare MₓSiO_{y}, wherein M is Li, Mg, and/or a (e.g., any suitable) combination thereof, x is 0.3 to 1.1, and y is 0.5 to 1.5, and ii) to increase a pore size (e.g., average pore size) of the porous amorphous carbon matrix, thereby preparing a reduction (e.g., reduced) product.

One or more embodiments of the present disclosure provides a rechargeable lithium battery including a negative electrode including the negative active material; a positive electrode, and a non-aqueous electrolyte.

A negative active material according to one or more embodiments may exhibit high capacity and excellent or suitable life-cycle characteristic.

### BRIEF DESCRIPTION OF THE DRAWINGS

The accompanying drawings are included to provide a further understanding of the present disclosure, and are incorporated in and constitute a part of this specification. The drawings illustrate example embodiments of the present disclosure and, together with the description, serve to explain principles of present disclosure. In the drawings:

FIG. 1 is a cross-sectional view schematically showing a negative active material according to one or more embodiments of the present disclosure.

FIG. 2 is an exploded cross-sectional view of a rechargeable lithium battery according to one or more embodiments of the present disclosure.

FIG. 3 is cross-sectional view of a rechargeable lithium battery according to one or more embodiments of the present disclosure.

FIG. 4 is an exploded view of a rechargeable lithium battery according to one or more embodiments of the present disclosure.

FIG. 5 is an exploded view schematically showing a rechargeable lithium battery according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

It will be understood that when an element, such as an area, layer, film, region or substrate, is referred to as being “on” another element, it can be directly on the other element, or one or more intervening elements may be present. In addition, it will also be understood that when an element is referred to as being “between” two elements, it can be the only element between the two elements, or one or more intervening elements may also be present.

As used herein, the singular forms “a,” “an” and “the” are intended to include the plural forms as well, unless the context clearly indicates otherwise. Unless otherwise specified, “A or B” may indicate “includes A, includes B, or includes A and B”.

As used herein, the term “combination thereof” may include a mixture, a laminate, a complex, a copolymer, an alloy, a blend, a reactant of constituents.

Unless otherwise noted, like reference numerals denote like elements throughout the attached drawings and the written description, and thus, duplicative descriptions thereof may not be provided. In the drawings, the relative sizes of elements, layers, and regions may be exaggerated for clarity.

It will be further understood that the terms “comprises,” “comprising,” “includes,” “including,” “have,” and “having,” when used in this specification, specify the presence of the stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from among a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the terms “use,” “using,” and “used” may be considered synonymous with the terms “utilize,” “utilizing,” and “utilized,” respectively.

In the present disclosure, when particles are spherical, “diameter” indicates a particle diameter or an average particle diameter, and when the particles are non-spherical, the “diameter” indicates a major axis length or an average major axis length. As used herein, when a definition is not otherwise provided, a particle diameter may be an average particle diameter. Such a particle diameter indicates an average particle diameter (D50) whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. The particle size (D50) may be measured by a method suitable, generally utilized and/or generally available to those skilled in the art, for example, by a particle size analyzer, or by a transmission electron microscopic image, or a scanning electron microscopic image. In one or more embodiments, a dynamic light-scattering measurement device may be used to perform a data analysis, and the number of particles are counted for each particle size range, and from this, the average particle diameter (D50) value may be easily obtained through a calculation. The particle size (diameter) may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In one or more embodiments, a thickness may be measured by a scanning electron microscopy (SEM) or a transmission electron microscopy (TEM) image for the cross-section, but the present disclosure is not limited thereto, and it may be measured by any techniques, as long as it may measure the thickness in the related art. The thickness may be an average thickness.

As used herein, soft carbon refers to graphitizable carbon materials and is readily graphitized by heat treatment at a high temperature, e.g., about 2800° C., and hard carbon refers to non-graphitizable carbon materials and is substantially and slightly graphitized by heat treatment. The soft carbon and the hard carbon are generally available and/or utilized in the related art.

A negative active material according to one or more embodiments includes a porous amorphous carbon matrix and a silicon oxide doped with a metal capable of undergoing a reduction.

A porosity of the negative active material may be about 5% to about 25%, about 7% to about 23%, or about 10% to about 20%.

If the porosity of the negative active material satisfies the above ranges, the volume expansion of silicon that may occur during charge and discharge may be effectively suppressed or reduced, thereby exhibiting improved life-cycle characteristic.

In one or more embodiments, the porosity may be measured by a Brunauer-Emmett-Teller (BET) method. For example, the porosity may be measured by the BET method using a nitrogen gas. For example, an amount of nitrogen adsorbed inside pores of the negative active material may be measured to quantify the pore volume, thereby obtaining porosity.

In one or more embodiments, the porous amorphous carbon matrix represents an amorphous carbon matrix with a porosity of about 20% or more. The porosity may be about 20% or more and about 64% or less. The porosity may be a value measured by the BET method and, for example, the porosity may be a value measured by the BET method using a nitrogen gas. The porosity of about 20% or more indicates a porosity of the porous amorphous carbon matrix used in the negative active material preparation.

The amorphous carbon may be hard carbon. If the amorphous carbon is hard carbon, it has lower lithium ion transfer resistance in the negative active material than other amorphous carbons such as soft carbon and/or the like, so that the charge speed is high and the mechanical strength is excellent or suitable, thereby suppressing or reducing silicon expansion inside.

In one or more embodiments, the porous amorphous carbon matrix includes at least one pore, and for example, may include pores with an average size (e.g., breadth or diameter) of about 1 nm to about 500 nm. The average size of the pores included in the porous amorphous carbon matrix may be about 1 nm to about 500 nm, or about 2 nm to about 400 nm. The average size of the pores may be larger than pores included in a porous amorphous carbon matrix used in the preparation. The average size of the pores within the above ranges may provide a sufficient buffer space which absorbs (buffers) the silicon volume expansion during charge and discharge, thereby suppressing or reducing the volume expansion of the negative active material, so that the cycle-life characteristic may be improved.

In one or more embodiments, the silicon oxide doped with a metal capable of undergoing reduction (hereinafter, referred as “metal doped silicon oxide”) may be positioned in the amorphous carbon matrix and for example, positioned in the pores of the amorphous carbon matrix. Volume expansion of the amorphous carbon may rarely occur during charge and discharge, and thus, if the metal doped silicon oxide is positioned in the amorphous carbon matrix, the volume expansion of silicon during charge and discharge may be effectively suppressed or reduced.

The negative active material according to one or more embodiments includes silicon as silicon oxide, for example, silicon oxide doped with the metal capable of (e.g., for) undergoing (e.g., to undergo) reduction and thus, it may inhibit or reduce a reaction generating lithium silicate by irreversibly reacting silicon with lithium transferred into the negative electrode during charging, thereby preventing or reducing irreversible lithium loss. This may improve the cycle-life characteristics.

In one or more embodiments, the metal capable of (e.g., for) undergoing (e.g., to undergo) reduction may a monovalent metal or a divalent metal, and for example, may be Li, Mg, and/or a (e.g., any suitable) combination thereof.

In one or more embodiments, the metal doped silicon oxide may be represented by MₓSiO_{y}. The x may be about 0.3 to about 1.1, or about 0.4 to about 1.0. The y may be about 0.5 to about 1.5, or about 0.6 to about 1.5. The M may be a monovalent metal or a divalent metal, and for example, it may be Li, Mg, and/or a (e.g., any suitable) combination thereof.

In the negative active material according to one or more embodiments, an amount of the metal doped silicon oxide may be, based on 100 wt % of the negative active material, about 15 wt % to about 60 wt %, about 16 wt % to about 55 wt %, about 17 wt % to about 50 wt %, or about 20 wt % to about 50 wt %. If the amount of the metal doped silicon oxide is within the above ranges, higher capacity may be realized.

A particle diameter of the metal dope silicon oxide may be about 1 nm to about 100 nm. about 2 nm to about 90 nm, or about 3 nm to about 50 nm. If the particle diameter of the metal doped silicon oxide satisfies the above ranges, the stress during volume expansion of the active material may be distributed, and thus, the effect of suppressing or reducing the volume expansion due to the use of the porous amorphous carbon matrix may be further enhanced.

The metal doped silicon oxide may be amorphous. The inclusion of the amorphous metal doped silicon oxide may not break in structure although charge/discharge cycles are repeated, thereby improving the cycle-life characteristics.

In the negative active material according to one or more embodiments, the amount of oxygen inherently included in the negative active material (generally at a maximum 30 wt %) may be reduced, for example, the amount of oxygen may be, based on 100 wt % of the negative active material, about 2 wt % to about 15 wt %, about 3 wt % to about 15 wt %, or about 3 wt % to about 14 wt %. Generally, oxygen included in the negative active material may irreversibly react with lithium, which may cause an increase in irreversible capacity. The negative active material according to one or more embodiments includes oxygen at the reduced amount of the above ranges, which may aid in decreasing the irreversible capacity, thereby exhibiting enhanced charge and discharge efficiency.

In one or more embodiments, the amount of oxygen may be measured by a pyrolysis technique. The pyrolysis technique may involve combusting a sample at a high temperature under an inert atmosphere without oxygen and analyzing the components of the gas generated by GC-MS (Gas Chromatography-Mass Spectrometry). The inert atmosphere may be Ar, N₂, and/or a (e.g., any suitable) combination thereof and the high temperature may be about 300° C. to about 700° C.

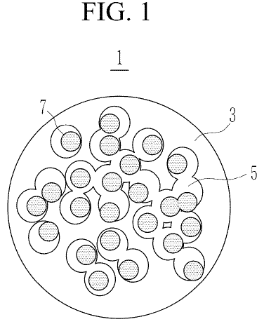

FIG. 1 schematically shows a cross-sectional view of the negative active material according to one or more embodiments of the present disclosure. The negative active material 1 includes a porous amorphous carbon matrix 3 and a metal doped silicon oxide 7 positioned in the pores 5.

As shown in FIG. 1, in the negative active material according to one or more embodiments, the inside of the pores may not be completely filled with the metal doped silicon oxide, but may be only partially filled. Thus, the negative active material may have a porosity of about 10% to about 20%, for example, about 11% to about 19%, or about 11% to about 18%.

### Method of Preparing Negative Active Material

The negative active material according to one or more embodiments may be prepared by the following procedures.

A negative active material preparation includes adding a porous amorphous carbon matrix and a metal compound capable of undergoing a reduction to a liquid silane compound to prepare a mixture; defoaming the mixture to prepare a defoamed product; condensing the defoamed product to prepare a condensed product; and reduction reacting the condensed product to prepare MₓSiO_{y} (where M is Li, Mg, and/or a (e.g., any suitable) combination thereof, x is 0.3 to 1.1, and y is 0.5 to 1.5) and to increase the pore size (e.g., average pore size) of the porous amorphous carbon matrix, thereby preparing a reduction product. Hereinafter, each process is illustrated.

A porous amorphous carbon matrix and a compound of a metal capable of undergoing reduction are added to a liquid silane compound to prepare a mixture. In the adding process, a solvent may be used. The solvent may be any solvent which is capable of dissolving the compound of the metal capable of (e.g., for) undergoing (e.g., to undergo) reduction. Example of the solvent may be alcohols such as methanol, ethanol, isopropanol, and/or the like.

The porous amorphous carbon matrix may be hard carbon.

The porous amorphous carbon matrix includes one or more pores and an average size of the pores may be about 1 nm to about 200 nm, about 1 nm to about 190 nm, or about 1 nm to about 180 nm.

In one or more embodiments, the porosity of the porous amorphous carbon matrix may be about 20% to about 64%, about 20% to about 60%, or about 20% to about 50%.

The compound including the metal capable of (e.g., for) undergoing (e.g., to undergo) reduction may be a metal capable of undergoing a reduction-included hydroxide, oxide, sulfide, and/or a (e.g., any suitable) combination thereof (e.g., the compound including the metal capable of (e.g., for) undergoing (e.g., to undergo) reduction may be a hydroxide, oxide, sulfide, and/or a (e.g., any suitable) combination thereof that includes the metal capable of (e.g., for) undergoing (e.g., to undergo) reduction). The metal capable of (e.g., for) undergoing (e.g., to undergo) reduction may be a monovalent metal, a divalent metal, and/or a (e.g., any suitable) combination thereof. For example, the metal capable of (e.g., for) undergoing (e.g., to undergo) reduction may be Li, Mg, and/or a (e.g., any suitable) combination thereof.

A mixing ratio of the porous amorphous carbon matrix, the compound including the metal capable of (e.g., for) undergoing (e.g., to undergo) reduction, and the liquid silane compound may be appropriately or suitably adjusted depending on the porosity of the porous amorphous carbon matrix, and for example, it may be appropriately or suitably adjusted an amount sufficient to fill the pores with the liquid silane compound, but the present disclosure is not limited thereto.

The silane compound is used as a silicon source material and it may be used in a liquid form to locate (position) the desired or suitable metal doped silicon oxide in the pores of the porous amorphous carbon matrix at an appropriate or suitable amount. If the silane compound is used in a vapor form, the pores of the porous amorphous carbon matrix may be blocked at the initiation of deposition and thus, the silane compound may be undesirably deposited on the surface of the porous amorphous carbon matrix. If the silane compound is used in a pulverized solid-phase, it may be not located in the pores of the porous amorphous carbon matrix which may make it to impossible to control the size of the silane compound relative to the size of the pores of the porous amorphous carbon matrix.

The liquid silane compound refers to a silane compound which exists in a liquid state at a room temperature, and the silane compound may be tetraalkyl orthosilicate, tetraalkoxysilane, silicon tetrachloride, and/or a (e.g., any suitable) combination thereof. The tetraalkyl orthosilicate may be tetramethyl orthosilicate, tetraethyl orthosilicate, tetrapropyl orthosilicate, and/or a (e.g., any suitable) combination thereof. The tetraalkoxy silane may be tetramethoxysilane, tetraethoxysilane, tetrabutoxysilane, and/or a (e.g., any suitable) combination thereof.

The mixture is subjected to defoaming to prepare a defoamed product. The defoaming may be carried out by a reduced vacuum pressure method. In the defoaming, air in the pores of the matrix may be removed and the liquid silane compound may penetrate into these pores.

The defoaming may be carried out under a vacuum condition. For example, it may be carried out by a reduced vacuum pressure. A pressure of the vacuum condition may be about 10⁻³M Pa to about 10⁻⁶ MPa. If the vacuum condition is set to the above pressure, the air in the pores may be sufficiently removed and then the pores may be completely and sufficiently filled with the liquid silane compound, allowing it to sufficiently penetrate into the pores.

The defoamed product is subjected to condensation to prepare a condensation product. Before condensation, a filtrating of the defoamed product and a washing with water may be further performed.

The condensation (e.g., the combining of two compounds to form a single compound) may be carried out by heat-treating at about 100° C. to about 200° C. The heat-treatment may be carried out at about 100° C. to about 190° C., or about 100° C. to about 180° C. During condensation, a condensation reaction of i) the compound of the metal capable of (e.g., for) undergoing (e.g., to undergo) reduction may undergo condensation with ii) the silane compound to thereby generate the condensation product (e.g., single compound) represented by MₓSiO₂ (M is the metal capable of (e.g., for) undergoing (e.g., to undergo) reduction, and is Li, Mg, and/or a (e.g., any suitable) combination thereof, and x is about 0.3 to about 1.1), for example, a compound represented by Structural Formula 1, if M is Li. Here, the condensation product or the compound represented by Structural Formula 1 may be located in the pores of the porous amorphous carbon matrix.

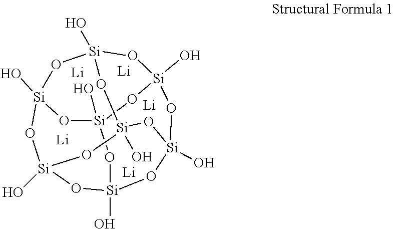

In this step (e.g., act or task), the pores of the amorphous carbon matrix may be substantially completely filled with MₓSiO₂, and for example, the porosity may be almost 0%.

Thereafter, the condensation product (e.g., MₓSiO₂) is subjected to reduction. The reduction step (e.g., act or task) may be carried out by sintering under an inert atmosphere such as nitrogen, argon, and/or a (e.g., any suitable) combination thereof. The reduction step (e.g., act or task) may be carried out at about 1300° C. to about 1700° C., about 1300° C. to about 1650° C. or about 1350° C. to about 1650° C.

According to the reduction, an oxygen atom of MₓSiO₂ reacts with a carbon atom of the carbon matrix to generate carbon monoxide and to reduce an amount of oxygen in the condensation product (e.g., MₓSiO₂), thereby producing MₓSiO_{y} (where x is about 0.3 to about 1.1 and y is about 0.5 to about 1.5), which is positioned in the pores of the amorphous carbon matrix. The generated carbon monoxide (CO) is volatilized and removed and size of the pores present in the porous amorphous carbon matrix increases (e.g., due to the loss of the carbon released in the carbon monoxide), and thus, the products obtained from the reduction, for example, the reduction product may have a larger pores volume than the pore volume of the porous amorphous carbon matrix prior to reduction. The size of pores present in the amorphous carbon matrix of the final negative active material may be increased to about 1 nm to about 500 nm.

The carbon monoxide may be removed to generate spaces in the pores, and thus, the final negative active material may have a porosity of about 5% to about 25%.

In addition, the size of the reduction product MₓSiO_{y} (where x is about 0.3 to about 1.1 and y is about 0.5 to about 1.5), is decreased relative to the condensation product MₓSiO₂, thus increasing the size of the pores relative to the size of the silicon reduction product MₓSiO_{y} (where x is about 0.3 to about 1.1 and y is about 0.5 to about 1.5) that is inside the pores.

### Rechargeable Lithium Battery

One or more embodiments of the present disclosure provide a rechargeable lithium battery including a negative electrode including the negative active material, a positive electrode, and an electrolyte.

### Negative Electrode

The negative electrode includes a current collector and a negative active material layer on the current collector. The negative active material layer may include the negative active material according to one or more embodiments, and may further include a binder and/or a conductive material.

In one or more embodiments, the negative active material according to one or more embodiments may be included as a first active material, and a material that reversibly intercalates/deintercalates lithium ions, a lithium metal, a lithium metal alloy, a material capable of doping/dedoping lithium, or a transition metal oxide may be included as a second active material.

A mixing ratio of the first active material and the second active material may be a weight ratio of about 99:1 to 10:90, or a weight ratio of about 90:10 to about 10:90.

The material that reversibly intercalates/deintercalates lithium ions may include a carbon-based negative electrode active material, such as, for example. crystalline carbon, amorphous carbon and/or a (e.g., any suitable) combination thereof. The crystalline carbon may be graphite such as unspecified-shaped, sheet-shaped (e.g., in the shape of sheets), flake-shaped (e.g., in the shape of flakes), sphere-shaped (e.g., in the shape of spheres), or fiber-shaped (e.g., in the shape of fibers) natural graphite or artificial graphite, and the amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), SiOₓ (0<x≤2) doped with or coated with Q (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof), Q-silicate (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof), and/or a combination thereof. SiOₓ doped with Q and/or coated with Q, or Q-silicate may be Li₂SiO₃, Li₂Si₂O₅, MgSiO₃, CaSiO₃, and/or the like. The Sn-based negative electrode active material may include Sn, SnOₓ (0<x≤2) (e.g., SnO₂) a Sn-based alloy, and/or a (e.g., any suitable) combination thereof.

The silicon-carbon composite may be a composite of silicon and amorphous carbon. According to one or more embodiments, the silicon-carbon composite may include silicon particles and an amorphous carbon coated on the surface of the silicon particle. For example, it may include secondary particles (core) where silicon primary particles are agglomerated and an amorphous carbon coating layer (shell) on the surface of the secondary particles. The amorphous carbon may be located between the silicon primary particles, for example, to coat on the silicon primary particles. The secondary particle may be presented by being distributed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

In the negative active material layer, an amount of the negative active material may be, based 100 wt % of the negative active material layer, about 95 wt % to about 99.5 wt %, or about 97 wt % to about 99.5 wt %. An amount of the binder may be about 0.5 wt % to about 5 wt %, or about 0.5 wt % to about 3 wt %.

In one or more embodiments, the negative active material layer may further include a conductive material. In embodiments further including the conductive material, based on the total 100 wt % of the negative active material, an amount of the negative active material may be about 90 wt % to 99 wt %, an amount of the binder may be about 0.5 wt % to about 5 wt %, and an amount of the conductive material may be about 0.5 wt % to about 5 wt %.

The binder included in the negative active material layer may be a non-aqueous binder, an aqueous binder, and/or a (e.g., any suitable) combination thereof. The non-aqueous binder or the aqueous binder may be as described above.

The binder included in the negative active material layer may include a cellulose compound and the cellulose compound may serve as a binder and may serve as a thickener for imparting viscosity. The cellulose-based compound may be used in an appropriate or suitable amount within the amount of the binder.

The cellulose-based compound includes one or more of carboxymethyl cellulose, hydroxypropyl methyl cellulose, methyl cellulose, and/or alkali metal salts thereof. The alkali metal may be Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

The conductive material is included to provide electrode conductivity (e.g., is an electron conductor). Any electrically conductive material may be used as a conductive material unless it causes a (substantial) chemical change. Examples of the conductive material may be a carbon-based material such as natural graphite, artificial graphite, carbon black, acetylene black, ketjen black, a carbon fiber, a carbon nanofiber, carbon nanotubes, and/or the like; a metal-based material of a metal powder or a metal fiber including copper, nickel, aluminum, silver, and/or the like; a conductive polymer such as a polyphenylene derivative; and/or a (e.g., any suitable) mixture thereof.

The current collector may include a copper foil, a nickel foil, a stainless steel foil, a titanium foil, a nickel foam, a copper foam, a polymer substrate coated with a conductive metal, and/or a (e.g., any suitable) combination thereof.

### Positive Electrode

The positive electrode may include a current collector and a positive electrode active material layer on the current collector. The positive electrode active material layer includes a positive electrode active material and may further include a binder and/or a conductive material.

In one or more embodiments, the positive electrode may further include an additive that may serve as a sacrificial positive electrode.

An amount of the positive active material may be, about 90 wt % to about 99.5 wt % based on 100 wt % of the positive active material layer, and amounts of the binder and the conductive material may each be 0.5 wt % to 5 wt % based on 100 wt % of the positive active material layer.

The positive active material may include a compound (lithiated intercalation compound) that is capable of intercalating and deintercalating lithium. In one or more embodiments, a (e.g., at least one or any) composite oxide of i) lithium and ii) a metal selected from among cobalt, manganese, nickel, and/or a (e.g., any suitable) combination thereof may be used.

The composite oxide may be a lithium transition metal composite oxide, and examples thereof may include lithium nickel-based oxide, lithium cobalt-based oxide, lithium manganese-based oxide, lithium iron phosphate-based compound, cobalt-free nickel-manganese-based oxide, and/or a (e.g., any suitable) combination thereof.

For example, the following compounds represented by any one or more of (e.g., selected from among) the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and/or LiₐFePO₄ (0.90≤a≤1.8).

In the above chemical formulas, A is Ni, Co, Mn, and/or a (e.g., any suitable) combination thereof; X is Al, Ni, Co, Mn, Cr, Fe, Mg, Sr, V, a rare earth element and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

For example, the positive electrode active material may be may be a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may realize high capacity and may be applied to a high-capacity, high-density rechargeable lithium battery.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, and/or the like, but the present disclosure is not limited thereto.

The conductive material is included to provide electrode conductivity (e.g., is an electron conductor), and any electrically conductive material may be used as a conductive material unless it causes a chemical change. Examples of the conductive material may include a carbon-based material such as natural graphite, artificial graphite, carbon black, acetylene black, Ketjen black, carbon fiber, carbon nanofiber, carbon nanotube, and/or the like; a metal-based material of a metal powder or a metal fiber including copper, nickel, aluminum, silver, and/or the like; a conductive polymer such as a polyphenylene derivative; and/or a (e.g., any suitable) mixture thereof.

The current collector may include Al, but the present disclosure is not limited thereto.

### Electrolyte

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, and may include a double bond, an aromatic ring, or an ether bond, and/or the like); amides such as dimethylformamide; dioxolanes such as 1,3-dioxolane, 1,4-dioxolane, and/or the like; sulfolanes, and/or the like.

The organic solvent may be used alone or in a mixture of two or more.

If the carbonate-based solvent is used, the cyclic carbonate and the linear carbonate may be used together therewith, and the cyclic carbonate and the linear carbonate may be mixed at a volume ratio of about 1:1 to about 1:9.

The lithium salt dissolved in an organic solvent supplies a battery with lithium ions, aids in operating the rechargeable lithium battery, and improves transportation of the lithium ions between positive and negative electrodes. Examples of the lithium salt include one or more electrolyte salts selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer of 1 to 20, lithium trifluoromethane sulfonate, lithium tetrafluoroethane sulfonate, lithium difluorobis(oxalato)phosphate (LiDFOB), and/or lithium bis(oxalato) borate (LiBOB).

### Separator

A separator may be arranged between the positive electrode and the negative electrode depending on a type or kind of a rechargeable lithium battery. The separator may use polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

The separator may include a porous substrate and a coating layer including an organic material, an inorganic material, and/or a (e.g., any suitable) combination thereof on a surface (e.g., one or both surfaces (opposite surfaces)) of the porous substrate.

The porous substrate may be a polymer film formed of any one selected from among a polyolefin such as polyethylene and polypropylene, a polyester such as polyethylene terephthalate and polybutylene terephthalate, polyacetal, polyamide, polyimide, polycarbonate, polyether ketone, polyaryl ether ketone, polyetherimide, polyamideimide, polybenzimidazole, polyether sulfone, polyphenylene oxide, a cyclic olefin copolymer, polyphenylene sulfide, polyethylene naphthalate, a glass fiber, and/or polytetrafluoroethylene (TEFLON), or a copolymer or mixture of two or more thereof.

The organic material may include a polyvinylidene fluoride-based polymer or a (meth)acryl-based polymer.

The inorganic material may be an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and an inorganic material may be mixed in one coating layer, or a coating layer including an inorganic material may be stacked.

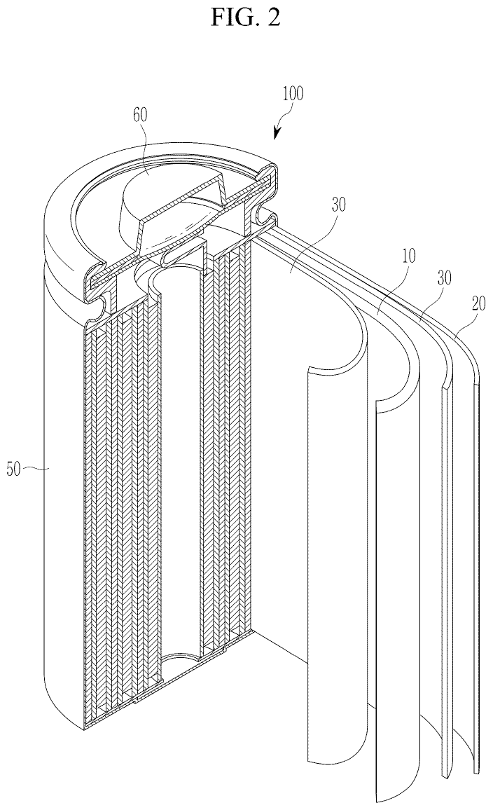

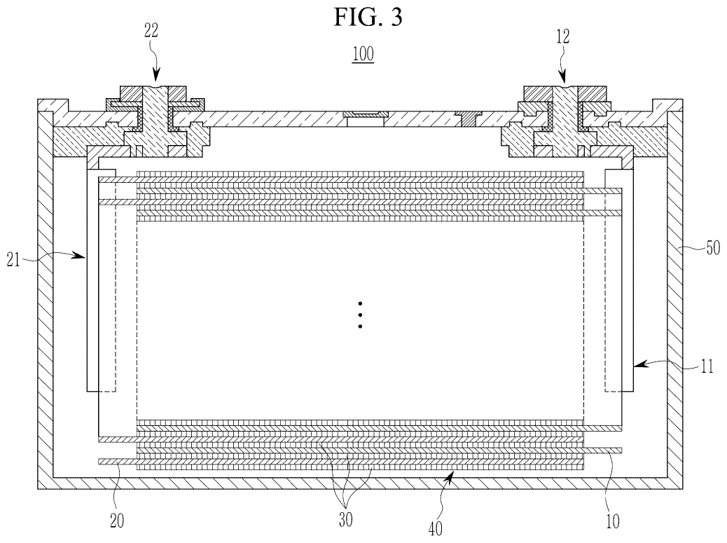

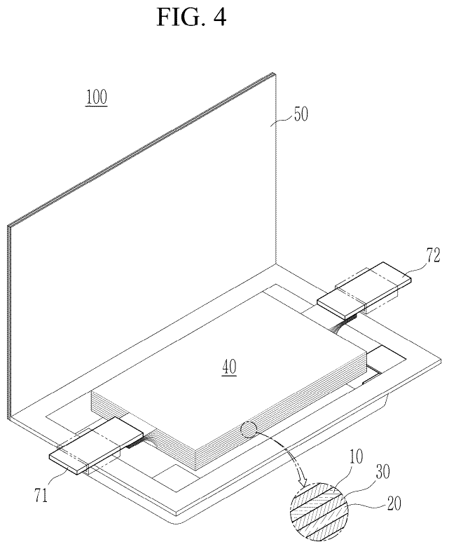

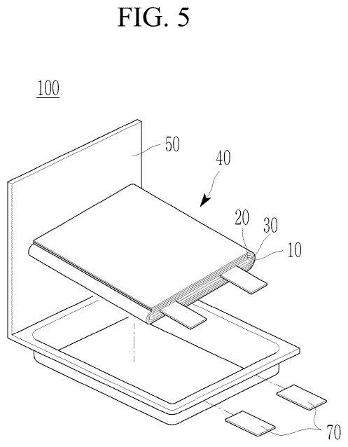

The rechargeable lithium battery may be classified into cylindrical, prismatic, pouch, or coin-type or kind batteries, and/or the like depending on their shape. FIG. 2 to FIG. 5 are schematic views illustrating a rechargeable lithium battery according to embodiments of the present disclosure, and FIG. 2 shows a cylindrical battery, FIG. 3 shows a prismatic battery, and FIG. 4 and FIG. 5 show pouch-type or kind batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 sealing the case 50, as shown, for example, in FIG. 2. In FIG. 3, the rechargeable lithium battery 100 may include a positive electrode lead tab 11 and a positive terminal 12, a negative electrode lead tab 21, and a negative terminal 22. As shown in FIG. 4 and FIG. 5, the rechargeable lithium battery 100 may include an electrode tab 70, which may be serving as an electrical path for inducing the current formed in the electrode assembly 40 to the outside, for example, a positive electrode tab 71 and a negative electrode tab 72.

The rechargeable lithium battery according to one or more embodiments may be applied to automobiles, mobile phones, and/or one or more suitable types (kinds) of electric devices, as non-limiting examples.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A porous hard carbon matrix (pore average size: 50 nm, BET porosity: 40%) and LiOH were added to liquid tetraethyl orthosilicate (TEOS) at a weight ratio of 50:11:39 to prepare a mixture.

The mixture was subjected to a defoaming process by a vacuum pressure reduction under a 10⁻⁶ MPa to prepare a defoamed product.

The defoamed product was filtrated and washed with water. Thereafter, the obtained product was condensed by heating (heat-treating) at 150° C. to prepare a condensation product including LiₓSiO₂ (x is 0.8).

The condensation product was subjected to reduction by sintering under a nitrogen atmosphere at 1500° C. to prepare a negative active material. In the reduction process, LiₓSiO₂ (x is 0.8) was reacted with a carbon atom in the carbon matrix to generate a carbon monoxide which was volatized to remove.

The prepare negative active material included the porous hard carbon matrix (pore average size: 92 nm), and a silicon oxide doped with Li (LiₓSiO_{y}, x is 0.8 and y is 1.1), positioned in the porous hard carbon matrix. An amount of the hard carbon matrix was 60 wt %, an amount of the silicon oxide doped with Li was 40 wt %, and a particle diameter of the silicon oxide doped with Li was 30 nm.

97.5 wt % of the prepared negative active material, 1 wt % of carboxymethyl cellulose, 1.5 wt % of a styrene butadiene rubber were mixed in a water solvent to prepare a negative active material layer slurry.

The negative active material layer slurry wad coated on a Cu foil current collector, dried, and pressurized to prepare a negative active material layer, thereby producing a negative electrode.

The negative electrode, a lithium metal counter electrode, and an electrolyte were used to fabricate a half-cell. As the electrolyte, a mixed solvent ethylene carbonate and dimethyl carbonate (3:7 volume ratio) in which 1M LiPF₆ was dissolved, was used.

### Example 2

A negative active material was prepared by the substantially the same procedure as in Example 1, except that the porous hard carbon matrix (pore average size: 50 nm, BET porosity: 40%) was changed to a porous hard matrix (pore average size: 10 nm, BET porosity: 40%).

A pore average size of the porous hard carbon matrix included in the prepared negative active material was 63 nm.

A negative electrode and a half-cell were fabricated by using the negative active material by substantially same procedure as in Example 1.

### Example 3

A negative active material was prepared by substantially the same procedure as in Example 1, except that Mg(OH)₂ was used instead of LiOH.

The prepare negative active material included the porous hard carbon matrix (pore average size: 93 nm), and a silicon oxide doped with Li (MgₓSiO_{y}, x is 0.8 and y is 1.1), positioned in the porous hard carbon matrix. An amount of the hard carbon matrix was 60 wt %, an amount of the silicon oxide doped with Mg was 40 wt %, and a particle diameter of the silicon oxide doped with Mg was 30 nm.

A negative electrode and a half-cell were fabricated using the negative active material by substantially the same procedure as in Example 1.

### Example 4

A negative active material was prepared by substantially the same procedure as in Example 2, except that Mg(OH)₂ was used instead of LiOH.

A pore average size of the porous hard carbon matrix included in the prepared negative active material was 65 nm.

A negative electrode and a half-cell were fabricated using the negative active material by substantially the same procedure as in Example 1.

### Comparative Example 1

A porous hard carbon matrix (pore average size: 50 nm, BET porosity: 40%) was added to liquid tetraethyl orthosilicate (TEOS) at a weight ratio of 48:52 to prepare a mixture.

The mixture was subjected to a defoaming process by a vacuum pressure reduction under a 10⁻⁶ MPa to prepare a defoamed product.

The defoamed product was filtrated and washed with water. Thereafter, the obtained product was condensed by heating (heat-treating) at 150° C. to prepare a condensation product.

The condensation product was subjected to reduction by sintering under a nitrogen atmosphere at 1500° C. to prepare a negative active material.

The prepare negative active material included the porous hard carbon matrix (pore average size: 92 nm), and a silicon oxide (SiO_{y}, wherein y is 1.1) positioned in the porous hard carbon matrix. An amount of the hard carbon matrix was 60 wt %, an amount of the silicon oxide was 40 wt %, and a particle diameter of the silicon oxide was 30 nm.

A negative electrode and a half-cell were fabricated using the negative active material by substantially the same procedure as in Example 1.

### Comparative Example 2

A porous hard carbon matrix (pore average size: 50 nm, BET porosity: 40%) and LiOH were added to liquid tetraethyl orthosilicate (TEOS) at a weight ratio of 50:11:39 to prepare a mixture.

The mixture was subjected to a defoaming process by a vacuum pressure reduction under a 10⁻⁶ MPa to prepare a defoamed product.

The defoamed product was filtrated and washed with water. Thereafter, the obtained product was condensed by heating (heat-treating) at 150° C. to prepare a condensation product, i.e., a negative active material.

A pore average size of the porous hard carbon matrix included in the prepared negative active material was 50 nm.

A negative electrode and a half-cell were fabricated by substantially the same procedure as in Example 1 using the negative active material.

### Comparative Example 3

A negative active material porous was prepared by substantially the same procedure as in Example 1, except that a porous graphite matrix (pore average size: 50 nm, BET porosity: 40%) was used instead of the porous hard carbon matrix.

A pore average size of the porous graphite matrix included in the prepared negative active material was 84 nm.

A negative electrode and a half-cell were fabricated by substantially the same procedure as in Example 1 using the negative active material.

### Experimental Results

### 1) Measurements of BET Porosity and Pore Size

Porosities for the negative active materials of Examples 1 to 4 and Comparative Examples 1 to 3 were measured by a BET measurement procedure using a nitrogen gas. The results are shown in Table 1.

In the negative active materials of Examples 1 to 4 and Comparative Examples 1 to 3, the pore sizes (i.e., average pore sizes) of the amorphous carbon matrixes were obtained by removing silicon oxide by a HF etching and measuring a nitrogen adsorption method. The results are shown in Table 1.

### 2) Measurement of Oxygen Amount

The oxygen amount included in the negative active materials of Examples 1 to 4 and Comparative Example 1 to 3 was measured by a pyrolysis technique. The results are shown in Table 1. The pyrolysis was carried out by analyzing gas components which were generated by combusting the negative active material at 500° C. under an Ar atmosphere, by Gas Chromatography-Mass Spectrometry (GC-MS).

### 3) Evaluation of Charge and Discharge Capacity

The half-cells according to Examples 1 to 4 and Comparative Examples 1 to 3 were charged and discharged once at 0.1 C to measure a charge and discharge capacity. The measured discharge capacity is shown in Table 1.

### 4) Evaluation of Efficiency

The half-cells according to Examples 1 to 4 and Comparative Examples 1 to 3 were charged and discharged once at 0.1 C. A ratio of discharge capacity relative to charge capacity was calculated. The results are shown in Table 1, as Efficiency.

### 5) Evaluation of Cycle-Life Characteristic

The half-cells according to Examples 1 to 4 and Comparative Examples 1 to 3 were charged and discharged at 1 C for 300 cycles. A ratio of discharge capacity at 300th cycle relative to discharge at 1^{st} cycle was calculated. The results are shown in Table 1, as Capacity Retention.

TABLE 1

| | | Pore | Amount of | Charge and | | Capacity |
|---|---|---|---|---|---|---|
| | Porosity | average | oxygen | discharge | Efficiency | retention |
| | (%) | size (nm) | (wt %) | capacity (mAh/g) | (%) | (%) |
| Example 1 | 10 | 92 | 9 | 1630 | 90 | 97 |
| Example 2 | 20 | 63 | 11 | 1850 | 91 | 99 |
| Example 3 | 10 | 93 | 12 | 1580 | 88 | 96 |
| Example 4 | 20 | 65 | 11 | 1820 | 90 | 99 |
| Comparative | 10 | 92 | 15 | 1530 | 65 | 53 |
| Example 1 | | | | | | |
| Comparative | 1 | 50 | 28 | 1210 | 69 | 62 |
| Example 2 | | | | | | |
| Comparative | 10 | 84 | 10 | 1640 | 87 | 71 |
| Example 3 | | | | | | |

As shown in Table 1, the cells of Examples 1 to 4 including the negative active materials having a porosity of 10% to 20% and including LiₓSiO_{y} and MgₓSiO_{y} exhibited excellent or suitable charge and discharge capacity, efficiency, and capacity retention.

In contrast, Comparative Example 1 including SiO_{y} but not including Li exhibited extremely low efficiency and capacity retention. Comparative Example 2 with a very low porosity of 1%, exhibited significantly low charge and discharge capacity, efficiency, and capacity retention.

Comparative Example 3 using the porous graphite matrix exhibited lower efficiency and capacity retention compared to the Examples.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. It is to be understood that the foregoing is an illustration of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A negative active material, comprising:
a porous amorphous carbon matrix; and
a silicon oxide doped with a metal for undergoing reduction,
wherein a porosity is about 5% to about 25%.

2. The negative active material as claimed in claim 1, wherein the metal comprises a monovalent or a divalent metal.

3. The negative active material as claimed in claim 1, wherein the metal comprises Li, Mg, or a combination thereof.

4. The negative active material as claimed in claim 1, wherein the porous amorphous carbon matrix comprises hard carbon.

5. The negative active material as claimed in claim 1, wherein the silicon oxide doped with the metal is represented by MₓSiO_{y}, and x is 0.3 to 1.1, y is 0.5 to 1.5, and M is a monovalent metal or a divalent metal.

6. The negative active material as claimed in claim 1, wherein the porosity of the negative active material is about 7% to about 23%.

7. The negative active material as claimed in claim 1, wherein an amount of silicon oxide doped with the metal is about 15 wt % to about 60 wt % based on 100 wt % of the negative active material.

8. The negative active material as claimed in claim 1, wherein the porous amorphous carbon matrix comprises pores with an average size of about 1 nm to about 500 nm.

9. The negative active material as claimed in claim 1, wherein the silicon oxide doped with the metal is positioned in pores of the porous amorphous carbon matrix.

10. The negative active material as claimed in claim 1, wherein the negative active material comprises oxygen in an amount of about 2 wt % to about 15 wt % based on 100 wt % of the negative active material.

11. A method comprising:
adding a porous amorphous carbon matrix and a metal for undergoing reduction with a liquid silane compound to prepare a mixture;
defoaming the mixture to prepare a defoamed product;
condensing the defoamed product to prepare a condensed product; and
reducing the condensed product
to prepare MₓSiO_{y}, wherein M is Li, Mg, or a combination thereof, x is 0.3 to 1.1, and y is 0.5 to 1.5, and
to increase an average pore size of the porous amorphous carbon matrix, thereby preparing a reduction product,
wherein the method is a method of preparing a negative active material.

12. The method as claimed in claim 11, wherein the porous amorphous carbon matrix after the reducing of the condensed product has a larger pore volume than the porous amorphous carbon matrix prior to the reducing of the condensed product.

13. The method as claimed in claim 11, wherein the defoaming is carried out under a reduced vacuum pressure having a pressure of about 10⁻³ MPa to about 10⁻⁶ MPa.

14. The method as claimed in claim 11, wherein the reducing of the condensed product produces carbon monoxide which is volatilized and removed.

15. The method as claimed in claim 11, wherein the reducing of the condensed product is carried out by sintering at about 1300° C. to about 1700° C. under an inert atmosphere of nitrogen, argon, or a combination thereof.

16. The method as claimed in claim 11, wherein the porous amorphous carbon matrix comprises hard carbon.

17. The method as claimed in claim 11, wherein the porous amorphous carbon matrix after the reducing of the condensed product has a porosity of about 20% to about 64%.

18. The method as claimed in claim 11, wherein the porous amorphous carbon matrix after the reducing of the condensed product comprises pores with an average size of about 1 nm to about 200 nm.

19. The method as claimed in claim 11, wherein the liquid silane compound comprises tetraalkyl orthosilicate, tetraalkoxysilane, silicon tetrachloride, or a combination thereof.

20. A rechargeable lithium battery, comprising:
a negative electrode comprising the negative active material of claim 1;
a positive electrode; and
a non-aqueous electrolyte.
